(19) United States
(12) Patent Application Publication
(10) Pub. No.: US 2009/0050624 A1
(43) Pub. Date: Feb. 26, 2009

(54) Top-a-plate

(76) Inventor: Wendy Rae Ventura, Metairie, LA (US)

Correspondence Address: Wendy Ventura, 3305 Clifford Drive, Metairie, LA, 70002, US

(21) Appl. No.: 12/002,281

(22) Filed: Jun. 9, 2008

Related U.S. Application Data
(60) Provisional application No. 60/965,254, filed on Aug. 20, 2007.

(51) Int. Cl. H05B 6/80; A47G 19/02; A47J 36/06

(52) U.S. Cl. 219/734; 220/574; 220/573.1

(57) ABSTRACT

The Microwavable Food Heating Package is an invention that combines two products into one product. A disposable, microwavable, paper plate and a disposable, microwavable cover that is molded to fit over the plate are sold together to form one product. The Microwavable Food Heating Package is mainly used for heating food. One grabs the plate and a cover with end tabs, lifts one or both tabs, puts the food on the plate, bends the tabs down, and heats the food. The Microwavable Food Heating Package can also be used to refrigerate food or to cover food so that objects do not get on the food. Since the entire product is disposable, there is no need to clean either portion of the product.

Applicant claims the benefit of the Provisional application 60/965,254 filed on Aug. 20, 2007.

Microwavable Food Heating Package is the title of the invention. It is a disposable, microwavable, paper plate with its own disposable, microwavable, non absorbent cover. It is not a heating, browning, or cooking apparatus, rather a convenient package consisting of a paper plate and a fitted cover together to hold and heat food while preventing a mess. It also serves as a temporary storage and protector of fresh food. This concept was created by Wendy Ventura, a citizen of the United States of America, who lives at 3305 Clifford Drive, Metairie, La. 70002.

### CROSS-REFERENCE TO RELATED APPLICATIONS

The Microwavable Food Heating Package concept incorporates two previously invented products. It uniquely melds the paper plate and the cover into a single retail product which is designed for ease and convenience.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Microwavable Food Heating Package represents a new retail product in the disposable paper plate industry. It combines a microwavable, disposable paper plate with its own fitted, microwavable, disposable cover into one product that stacks for retail sale and easy storage. The market audience is already in place as the paper plate industry has existed for a long time (1904). In addition, there is a market for paper towels, plastic wrap, and wax paper which are products that have been used to cover food. Since microwaves have been sold, some consumers have heated food in paper plates and have covered their food with the above items. Microwavable Food Heating Package eliminates the direct need for having a roll of paper towels, a box of plastic wrap, or a box of wax paper immediately accessible when one is heating food in the microwave. Microwavable Food Heating Package is a product that offers an immediate resolve to food splashes when heating food in the microwave. As a result, the microwave will not need to be cleaned as often as without a Microwavable Food Heating Package. Also, when paper towels are used to cover food in the microwave, they often absorb gravy and liquid and may create quite a mess. The Microwavable Food Heating Package cover would offer a welcome alternative as its design and texture would not allow absorption.

The top market audience for Microwavable Food Heating Package is females, especially working mothers, who constantly seek out “new” products or improved products that offer convenience, time savings, and ease so that they may devote and focus more attention on personal and professional endeavors.

Microwavable Food Heating Package can be used at home, for work pot luck lunches, as well as at picnics. Microwavable Food Heating Package (featuring an adhesive grip covering) offers an imminent solution to outdoor and picnic related functions—eliminating the physical step of wrapping uneaten food products in individual paper plates (often in breezy conditions). Microwavable Food Heating Package also presents a quick defense against ever present and annoying flies. There is no such product on the market which combines a paper plate and its own covering as one convenient product.

### BRIEF SUMMARY OF THE INVENTION

Microwavable Food Heating Package is a uniquely designed mass market product which conveys simplicity and convenience by combining two “kitchen” products (a standard paper plate with its own fitted microwavable disposable cover) into one new, suitable product. Convenience is the overriding theme of this product, which has no direct competition in the retail grocery market at this time. To warm food in a paper plate, one currently needs to use an improvised cover (out of paper towels or wax paper or plastic wrap) to contain food splatters when using a microwave. Additionally, one has to use similar improvisation when heating food at work or wrapping food at a picnic. Microwavable Food Heating Package will provide both the paper plate and the covering (which includes adhesive end grips), to be sold in a traditional stack formation common among paper or plastic plate products.

### BRIEF DESCRIPTION OF THE VIEWS OF THE DRAWINGS

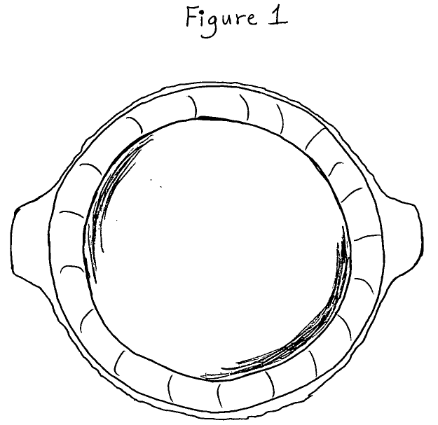

The illustration in FIG. 1 shows a top view of a paper plate with a cover over it. The cover fits over the plate with two tabs that are across from one another.

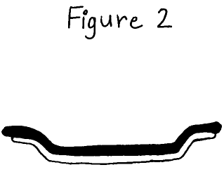

The illustration in FIG. 2 shows a side view of a paper plate (dissected) with the cover that is molded to fit inside the plate to allow stacking. Upon usage, the cover is simply pulled up from either/both side(s) so that the plate may be filled with food. The cover is then placed over the plate for heating, refrigeration, protection, or to help sustain freshness.

### DETAILED DESCRIPTION OF THE INVENTION

Microwavable Food Heating Package represents a melding of two products into one. A standard durable paper plate (varying patterns, shapes, and/or sizes, microwavable, disposable) is the first product. A fitted, molded, disposable and microwavable cover featuring a high tolerance against tears and two ends with adhesive grip properties is the second product. The covering is actually a new product itself in the sense that it is cut and sculpted to fit in, around, and over the plate. The two products are sold together as one and may be packaged the same way current paper plate products are delivered to market. For convenience, a paper plate and a cover will be sold together with one stacked on top of the other. When one grabs a paper plate, the cover will be with it for added convenience. Microwavable Food Heating Package is specifically designed for heating and/or temporarily storing food using a disposable product. It represents a complete product in the sense that two separately sold products are no longer needed to heat or temporarily cover food. Microwavable Food Heating Package is distinguishable in this sense. Currently, the paper plate/disposable plate industry offers stacks of plates for sale in retail stores. There is one disposable plastic plate product featuring plates that can be turned upside down and interlocked with other plates. However, this can be somewhat wasteful in a sense that two plates are needed to accomplish the task. Styrofoam containers with lids are also sold, but are somewhat cumbersome and bulky, and therefore difficult to store as unused items. Microwavable Food Heating Package is designed to be stacked the same way as regular paper plates.

The entire R & D (Research and Development) associated with this product will focus on the paper plate covering—the exact make-up and texture, the adhesive grip ends and the mass production line packaging. In addition to a standard tolerance against rips or tears the cover should also feature basic insulation properties. The covering may be lifted from either end to load food onto the paper plate while the opposite end remains gripped to the plate. The open end is then pulled down to cover the food. Microwavable Food Heating Package is entirely microwavable, sturdy enough to refrigerate, and eventually disposable. Manufacturing may consider recycled products.

1. I claim the Microwavable Food Heating Package, a microwavable, disposable package consisting of a paper plate and a fitted flexible, non absorbent cover designed to be marketed as one unit that can be used for microwave heating of food or for temporary storage or protection of fresh food.
